(19) United States
(12) Patent Application Publication
(10) Pub. No.: US 2024/0362675 A1
(43) Pub. Date: Oct. 31, 2024

(54) SYSTEMS AND METHODS FOR PROVIDING PERSONALIZED OFFERS AND INFORMATION

(71) Applicant: RevLifter Ltd., London (GB)

(72) Inventors: Adam Gordon Manners, Waltham Cross (GB); Matt Payne, Northamptonshire (GB); Michael Payne, Flintshire (GB)

(73) Assignee: RevLifter Ltd., London (GB)

(21) Appl. No.: 18/307,363

(22) Filed: Apr. 26, 2023

(51) Int. Cl. G06Q 30/0251; G06Q 30/0241

(52) U.S. Cl. CPC G06Q 30/0253; G06Q 30/0255; G06Q 30/0263; G06Q 30/0277

(57) ABSTRACT

A personalized offer and information system that may be integrated with retailers' websites so as to provide users of the websites with personalized offers and contextual information, such as product recommendations. Retailers may define offers and conditions to be met for the offers to become available to users. The personalized offer and information system may detect interactions of a user with a retailer website and use such interactions to update a user profile. The user profile and the conditions of the offers may be used to generate personalized offers and information for the user. The personalized offer and information system may provide a widget that visually indicates to users that personalized offers are available and a panel in which the personalized offers are displayed. Users may select the widget to have the panel become visible. The widget may persist the personalized offers and information for the user across user sessions.

### FIELD OF THE INVENTION(S)

Embodiments of the present invention(s) are generally related to providing personalized offers and information, and in particular to providing personalized offers and contextual information, such as product or services recommendations, to users of retailer websites.

### BACKGROUND

A website that provides products or services for sale may provide offers to entice users to purchase a product or service. However, the website may display the offers only on a landing page or home page, and not on other pages of the website. Or the website may display offers only in a navigation section which the user may have to access in order to view the offers. In either case, the user may have difficulty accessing or finding offers on the website.

The website may also provide offers at a less than useful point in the buying process of the user. For example, the user may be only researching products or services and not intending to purchase a product or service. The website may nonetheless provide offers to the user during the research. However, if the user leaves the website and returns later to purchase the researched product or service, the website may not necessarily resurface the offers that were initially provided to the user during the research. Accordingly, the user may not be able to find the offers and may lose commitment to purchasing the researched product or service.

Moreover, the website may provide offers to the user, but may not provide any personalized encouragement to the user to help the user qualify for the offers. For example, an offer may only become valid if the user selects a threshold value of products or services for purchase. If the user has selected products or services for purchase, the user may not be aware of the value of additional products or services the user needs to select for purchase in order to meet the threshold value and qualify for the offer.

### SUMMARY

In some aspects, the techniques described herein relate to a non-transitory computer-readable medium including executable instructions, the executable instructions being executable by one or more processors to perform a method, the method including: detecting, using a tag associated with a website providing multiple products for sale, a first interaction of a user with the website, the website operated by a first entity, the tag provided by a second entity distinct from the first entity, the website having a first theme; determining that the first interaction of the user with the website satisfies one or more criteria for activating a campaign to provide the user with one or more offers of multiple offers for one or more products of the multiple products, the campaign including the multiple offers for the one or more products of the multiple products, the campaign and the multiple offers for the one or more products of the multiple products defined by the first entity and provided to the second entity; activating the campaign; detecting, using the tag, second interactions of the user with the website, the second interactions including at least one of the user viewing one or more products of the multiple products, the user selecting one or more products of the multiple products for purchase, and the user purchasing one or more products of the multiple products; updating a profile of the user to include the second interactions of the user with the website; evaluating the multiple offers for the one or more products of the multiple products and the profile of the user to identify one or more particular offers of the multiple offers to display to the user; identifying one or more particular offers of the multiple offers for the one or more products of the multiple products to display to the user; displaying to the user a visual indication of the one or more particular offers on the website, the visual indication having a second theme consistent with the first theme of the website; receiving a selection by the user of the visual indication; and displaying to the user the one or more particular offers in a panel on the website, the panel and the one or more particular offers having the second theme that is consistent with the first theme of the website.

In some aspects, the techniques described herein relate to a non-transitory computer-readable medium, the method further including identifying one or more rules associated with the multiple offers for the one or more products of the multiple products, at least one rule of the one or more rules including one or more conditions, and wherein: evaluating the multiple offers for the one or more products of the multiple products and the profile of the user to identify one or more particular offers of the multiple offers to display to the user includes evaluating the one or more rules and the profile of the user to determine if the one or more conditions of the at least one rule are met, and identifying one or more particular offers of the multiple offers for the one or more products of the multiple products to display to the user includes determining that the one or more conditions of the at least one rule are met.

In some aspects, the techniques described herein relate to a non-transitory computer-readable medium, the method further including identifying one or more priorities associated with the one or more particular offers, wherein displaying to the user the one or more particular offers in a panel on the website includes displaying the one or more particular offers in a panel in an order based on the one or more priorities associated with the one or more particular offers.

In some aspects, the techniques described herein relate to a non-transitory computer-readable medium, wherein a particular offer of the one or more particular offers includes a threshold value of products to be selected for purchase to be met to qualify for the particular offer, and the method further including: displaying to the user a progress visual indicator in the particular offer, the progress visual indicator indicating a progress of the user in qualifying for the particular offer; determining that the user has selected one or more products of the multiple products for purchase; updating the progress visual indicator to obtain an updated progress visual indicator, the updated progress visual indicator indicating the progress of the user in qualifying for the particular offer; and displaying the updated progress visual indicator in the particular offer.

In some aspects, the techniques described herein relate to a non-transitory computer-readable medium wherein the panel includes an inline frame that is hidden by the website prior to displaying to the user the one or more particular offers in a panel on the website, the method further including causing the website to display the inline frame after receiving a selection by the user of the visual indication, and wherein displaying to the user the one or more particular offers in a panel on the website includes displaying to the user the one or more particular offers in the inline frame.

In some aspects, the techniques described herein relate to a non-transitory computer-readable medium wherein the one or more particular offers include at least one of a discount code for one or more products of the multiple products and a link to one or more products of the multiple products.

In some aspects, the techniques described herein relate to a non-transitory computer-readable medium wherein the one or more particular offers include one or more recommendations for one or more products of the multiple products, wherein the one or more recommendations are based on the second interactions of the user with the website, the second interactions including the user viewing one or more products of the multiple products.

In some aspects, the techniques described herein relate to a non-transitory computer-readable medium wherein the second interactions include the user viewing one or more products of the multiple products and the method further including: obtaining information regarding the one or more products of the multiple products, the information including at least one of one or more names, one or more prices, and one or more images of the one or more products of the multiple products; storing the information regarding the one or more products of the multiple products in a products datastore; accessing the products datastore to generate the one or more recommendations for one or more products of the multiple products; and generating the one or more recommendations for the one or more products of the multiple products.

In some aspects, the techniques described herein relate to a non-transitory computer-readable medium wherein the tag includes executable instructions being executable by one or more processors of a digital device of the user.

In some aspects, the techniques described herein relate to a method including: detecting a first interaction of a user with a website, the website providing multiple products or services for sale; determining that the first interaction of the user with the website satisfies one or more criteria for activating a campaign to provide the user with one or more offers of multiple offers for one or more products or services of the multiple products or services, the campaign including the multiple offers for the one or more products or services of the multiple products or services; activating the campaign; detecting second interactions of the user with the website, the second interactions including at least one of the user viewing one or more products or services of the multiple products or services, the user selecting one or more products or services of the multiple products or services for purchase, and the user purchasing one or more products or services of the multiple products or services; updating a profile of the user, the profile including the second interactions of the user with the website; evaluating the multiple offers for the one or more products or services of the multiple products or services and the profile of the user to identify one or more particular offers of the multiple offers to display to the user; identifying one or more particular offers of the multiple offers for the one or more products or services of the multiple products or services included in the campaign to display to the user; and displaying the one or more particular offers on the website.

In some aspects, the techniques described herein relate to a method, further including: prior to displaying the one or more particular offers on the website, displaying a visual indication of the one or more particular offers on the website and receiving a selection by the user of the visual indication, and wherein displaying the one or more particular offers on the website includes displaying the one or more particular offers in a panel on the website.

In some aspects, the techniques described herein relate to a method wherein the panel includes an inline frame that is hidden by the website prior to displaying to the user the one or more particular offers in a panel on the website, the method further including causing the website to display the inline frame after receiving a selection by the user of the visual indication, and wherein displaying to the user the one or more particular offers in a panel on the website includes displaying to the user the one or more particular offers in the inline frame.

In some aspects, the techniques described herein relate to a method, further including identifying one or more rules associated with the multiple offers for the one or more products or services of the multiple products or services, at least one rule of the one or more rules including one or more conditions, and wherein: evaluating the multiple offers for the one or more products or services of the multiple products or services and the profile of the user to identify one or more particular offers of the multiple offers to display to the user includes evaluating the one or more rules and the profile of the user to determine if the one or more conditions of the at least one rule are met, and identifying one or more particular offers of the multiple offers for the one or more products or services of the multiple products or services to display to the user includes determining that the one or more conditions of the at least one rule are met.

In some aspects, the techniques described herein relate to a method, further including identifying one or more priorities associated with the one or more particular offers, wherein displaying to the user the one or more particular offers on the website includes displaying the one or more particular offers in a panel on the website in an order based on the one or more priorities associated with the one or more particular offers.

In some aspects, the techniques described herein relate to a method wherein a particular offer of the one or more particular offers includes a threshold value of products or services to be selected for purchase to be met to qualify for the particular offer, and the method further including: displaying to the user a progress visual indicator in the particular offer, the progress visual indicator indicating a progress of the user in qualifying for the particular offer; determining that the user has selected one or more products or services of the multiple products or services for purchase; updating the progress visual indicator to obtain an updated progress visual indicator, the updated progress visual indicator indicating the progress of the user in qualifying for the particular offer; and displaying the updated progress visual indicator in the particular offer.

In some aspects, the techniques described herein relate to a method wherein the one or more particular offers include at least one of a discount code for one or more products or services of the multiple products or services and a link to one or more products or services of the multiple products or services.

In some aspects, the techniques described herein relate to a method wherein the one or more particular offers include one or more recommendations for one or more products or services of the multiple products or services, wherein the one or more recommendations are based on the second interactions of the user with the website, the second interactions including the user viewing one or more products or services of the multiple products or services.

In some aspects, the techniques described herein relate to a method wherein the second interactions include the user viewing one or more products of the multiple products, and the method further including: obtaining information regarding the one or more products or services of the multiple products or services, the information including at least one of one or more names, one or more prices, and one or more images of the one or more products or services of the multiple products or services; storing the information regarding the one or more products or services of the multiple products or services in a products datastore; accessing the products datastore to generate the one or more recommendations for one or more products or services of the multiple products or services; and generating the one or more recommendations for the one or more products or services of the multiple products or services.

In some aspects, the techniques described herein relate to a method wherein detecting the first interaction of the user with the website includes detecting, using a tag associated with the website, the first interaction of the user with the website, detecting second interactions of the user with the website includes detecting, using the tag, the second interactions of the user with the website, and the tag includes executable instructions being executable by one or more processors of a digital device of the user.

In some aspects, the techniques described herein relate to a system including at least one processor and memory containing instructions, the instructions being executable by the at least one processor to: detect a first interaction of a user with a website, the website providing multiple products or services for sale; determine that the first interaction of the user with the website satisfies one or more criteria for activating a campaign to provide the user with one or more offers of multiple offers for one or more products or services of the multiple products or services, the campaign including the multiple offers for the one or more products or services of the multiple products or services; activate the campaign; detect second interactions of the user with the website, the second interactions including at least one of the user viewing one or more products or services of the multiple products or services, the user selecting one or more products or services of the multiple products or services for purchase, and the user purchasing one or more products or services of the multiple products or services; update a profile of the user, the profile including the second interactions of the user with the website; evaluate the multiple offers for the one or more products or services of the multiple products or services and the profile of the user to identify one or more particular offers of the multiple offers to display to the user; identify one or more particular offers of the multiple offers for the one or more products or services of the multiple products or services included in the campaign to display to the user; and display the one or more particular offers on the website.

### BRIEF DESCRIPTION OF THE DRAWINGS

FIG. 1 is a block diagram depicting an example environment in which personalized offers and information may be provided in some embodiments.

FIG. 2A is a block diagram depicting components of a personalized offer and information system in some embodiments.

FIG. 2B is a block diagram depicting data flow between certain components of a personalized offer and information system and a retailer website in some embodiments.

FIG. 3 is a flow diagram depicting a method for generating personalized offers and information in some embodiments.

FIGS. 4A-4C depict example user interfaces for personalized offers and information in some embodiments.

FIG. 4D is a block diagram depicting a campaign, offers, and rules in some embodiments.

FIG. 4E is a block diagram depicting priorities of offers in some embodiments.

FIG. 5 depicts an example user interface displaying a visual indication of offers in some embodiments.

FIG. 6 depicts the example user interface of FIG. 5 with a panel in which offers are displayed in some embodiments.

FIG. 7 depicts another example user interface showing a product selected for purchase in some embodiments.

FIG. 8 depicts the example user interface of FIG. 5 with the panel displaying an offer having an updated progress visual indicator in some embodiments.

FIG. 9 depicts the example user interface of FIG. 5 displaying an additional offer in some embodiments.

FIG. 10 depicts another example user interface displaying another visual indication of offers in some embodiments.

FIG. 11 depicts the example user interface of FIG. 10 with a panel in which offers are displayed in some embodiments.

FIG. 12 depicts the example user interface of FIG. 11 displaying an offer with product recommendations in the panel in some embodiments.

FIG. 13 depicts the example user interface of FIG. 11 displaying product recommendations in the panel in some embodiments.

FIG. 14 is a block diagram depicting an example digital device in some embodiments.

Throughout the drawings, like reference numerals will be understood to refer to like parts, components, and structures.

### DETAILED DESCRIPTION

The personalized offer and information system described herein may be integrated with websites of retailers so as to provide users of the websites with personalized offers and contextual information, such as product recommendations. Retailers may define offers and conditions to be met for the offers to become available to users. The personalized offer and information system may detect interactions of a user with a retailer website and use such interactions to update a user profile. The personalized offer and information system may utilize the user profile and the conditions of the offers to identify personalized offers and information for the user. The personalized offer and information system may provide a first user interface element, such as a widget, that visually indicates to users that personalized offers are available and second user interface element, such as a panel, in which the personalized offers are displayed. The panel may be initially hidden, and users may select the widget to have the panel become visible. The widget may also visually indicate the number of personalized offers available to users. The widget may also persist the personalized offers and information for users across sessions so that users may see the personalized offers and information every time the users return to the retailer website.

When a user accesses the retailer website, the personalized offer and information system detects the user access and determine if the user access triggers the start of a campaign. The campaign may include numerous offers that the user may be eligible for. If the personalized offer and information system starts the campaign, the personalized offer and information system detects user interactions with the retailer website, such as products or services the user views and/or selects for purchase. The personalized offer and information system builds a user profile based on the detected user interactions and determines what offers, if any, to show the user based on the user profile and the available offers. The personalized offer and information system may also use the user profile to determine personalized contextual information, such as product or category recommendations, to show to the user. If the user is eligible for offers, the personalized offer and information system causes the widget to display a visual indication of the offers. This may be done by updating a counter of the widget or by causing the widget to display text indicating that the user has offers available. The panel may be initially hidden, and the user may select the widget to see the offers. The personalized offer and information system may then display the panel in which the personalized offers and other information are displayed. The user may close the panel. However, the personalized offer and information system may continue to display the widget, which enables the user to see that the user still has offers available.

An offer may include a countdown timer that indicates for how much longer the offer is available and/or a progress bar that indicates an amount of progress the user has made towards qualifying for the offer and an amount of progress the user still has to make to qualify for the offer. For example, the countdown timer may indicate that an offer may expire in a period of 24 hours from the time the user first viewed the offer. As another example, an offer may provide free shipping or a discount code if the user purchases or selects for purchase products or services whose value exceeds a threshold amount. The progress bar may indicate to the user the progress the user has made and the progress the user still has to make to qualify for the offer based on the value of the products or services the user has selected for purchase.

The personalized offer and information system described herein may provide numerous advantages. First, by basing the offers and information on the interactions of the user with the retailer website, the personalized offer and information system provides offers and information that are likely more relevant and meaningful to the user. Second, by providing personalized offers and information to the user, the personalized offer and information system may increase the likelihood of the user purchasing a product or service and may increase engagement of the user with the retailer website. Accordingly, the conversion rate of the retailer may increase and the brand loyalty of the user to the retailer may also increase. Third, by providing countdown timers and progress bars to the user, the personalized offers and information may encourage or incentivize the user to take actions to redeem the offer and/or qualify for the offer. Such encouragement may result in the user purchasing more products or services than the user would purchase without the encouragement. Accordingly, the personalized offer and information system may increase the average order value (AOV) of the retailer.

Another advantage is that the widget provides a persistent and easily accessible hub for personalized offers and information. Even if the user closes the panel displaying the personalized offers and information, the personalized offer and information system may continue to display the widget to the user throughout the user journey on the retailer website. At any point during their browsing the user may select the widget to see the offers and information available to the user. Accordingly, the personalized offer and information system may reduce any difficulty the user has in finding and redeeming offers, which difficulty may occur if offers are only on landing pages and/or in navigation sections. The personalized offer and information system may persist the personalized offers and information to the user regardless of whether the user is signed in or not and across visits by the user to the retailer website that are spaced apart in time. Such persistence of the personalized offers and information may help build loyalty of the user to the retailer and increase the likelihood of the user purchasing products or services from the retailer website in the future.

Although many examples herein describe the personalized offers and information system providing personalized offers and information to a single user at a single retailer website, the personalized offers and information system is scalable to numerous users at a single retailer website and to numerous retailer websites. In other words, the personalized offers and information system may provide personalized offers and information to any number of users at any number of websites. The scalability of the personalized offers and information is due, in part, to the architecture of the personalized offers and information system. The architecture of the personalized offers and information system allows the personalized offers and information system to, in real-time or near real-time, detect user interactions, update user profiles, and provide personalized offers and information to numerous users, all in a low-latency or near low-latency fashion. Accordingly, the personalized offers and information system is scalable to meet the demands of retailers to provide personalized offers and information to the users of the retailers' websites.

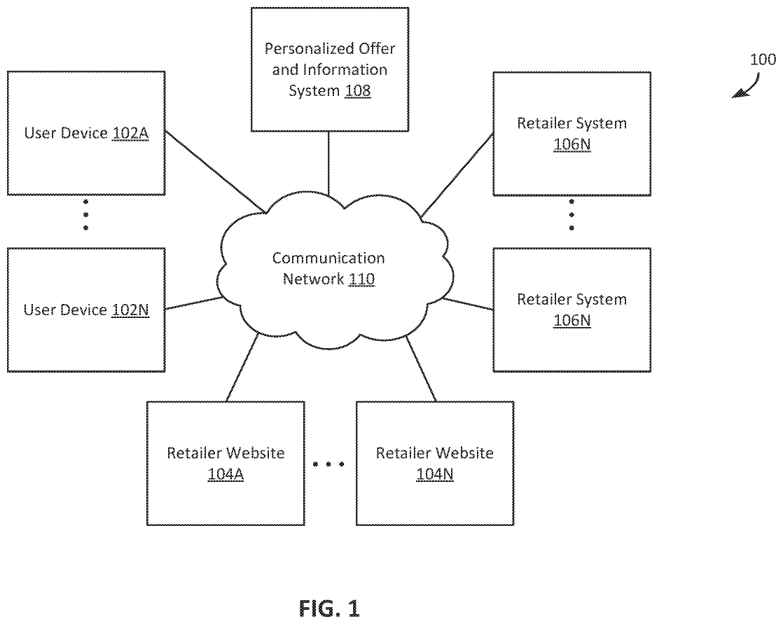

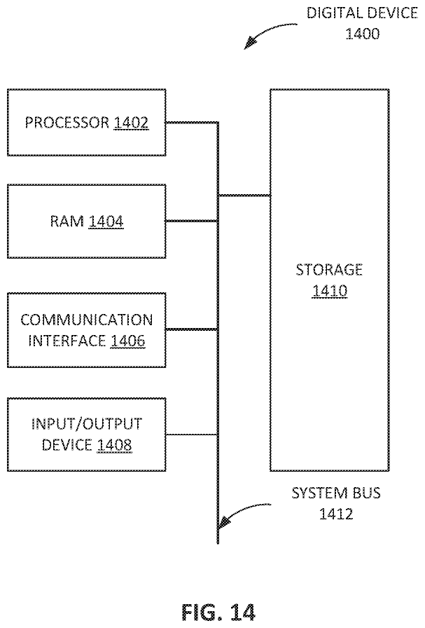

FIG. 1 depicts an example environment 100 in which personalized offers and information may be provided in some embodiments. The example environment 100 includes multiple user devices 102A through 102N (referred to as a user device 102 or user devices 102), multiple retailer websites 104A through 104N (referred to as a retailer website 104 or retailer websites 104), multiple retailer systems 106A through 106N (referred to as a retailer system 106 or retailer systems 106), a personalized offer and information system 108, and a communication network 110. Each of the user device 102, the retailer website 104, the retailer system 106, and the personalized offer and information system 108 may be or include any number of digital devices. A digital device is any device with at least one processor and memory. Digital devices are discussed further herein, for example, with reference to FIG. 14.

A first entity such as a retailer may operate a retailer website 104. The retailer website 104 may provide products or services for sale. A user may use a user device 102 to access the retailer website 104 in order to view products or services, select products or services for purchase, and/or purchase products or services. A second entity, distinct from the first entity, may operate the personalized offer and information system 108.

The personalized offer and information system 108 may provide personalized offers and information to the retailer website 104 for display to the user on the user device 102. The retailer may also operate the retailer system 106 to perform various functions, including configuring the retailer website 104 and sending requests and/or data to and receiving requests and/or data from the personalized offer and information system 108. For example, the retailer may utilize the retailer system 106 to define campaigns, offers, and rules that the personalized offer and information system 108 uses to provide personalized offers to the retailer website 104 for display to the user on the user device 102.

In some embodiments, the communication network 110 may represent one or more computer networks (for example, LAN, WAN, and/or the like). The communication network 110 may provide communication between any of the user device 102, the retailer website 104, the retailer system 106, and the personalized offer and information system 108. In some implementations, the communication network 110 comprises computer devices, routers, cables, and/or other network topologies. In some embodiments, the communication network 110 may be wired and/or wireless. In various embodiments, the communication network 110 may comprise the Internet, one or more networks that may be public, private, IP-based, non-IP based, and so forth.

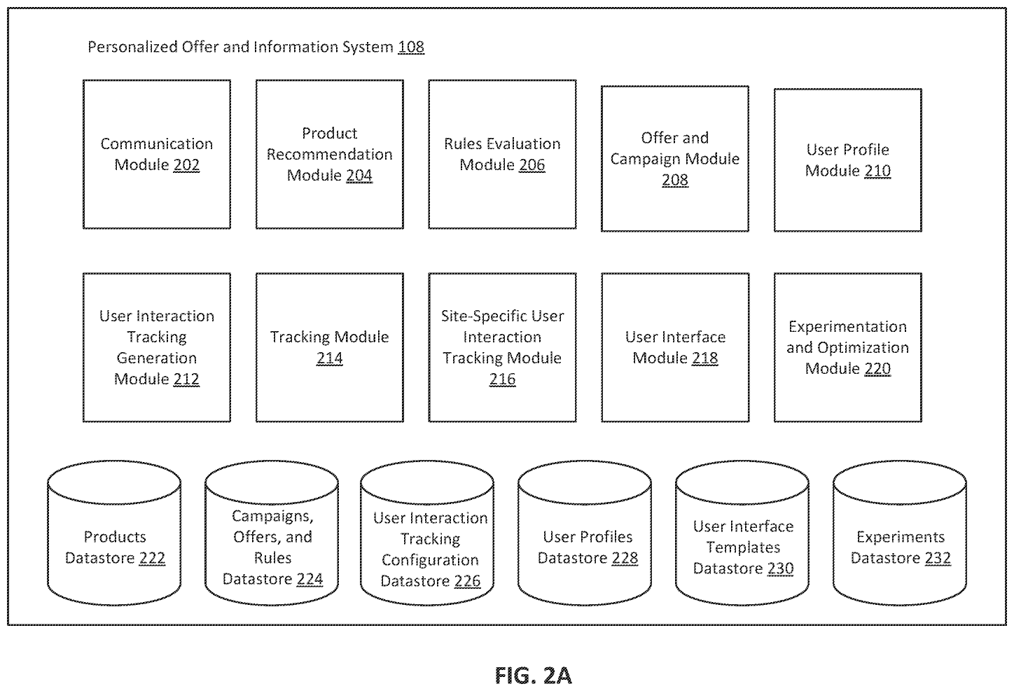

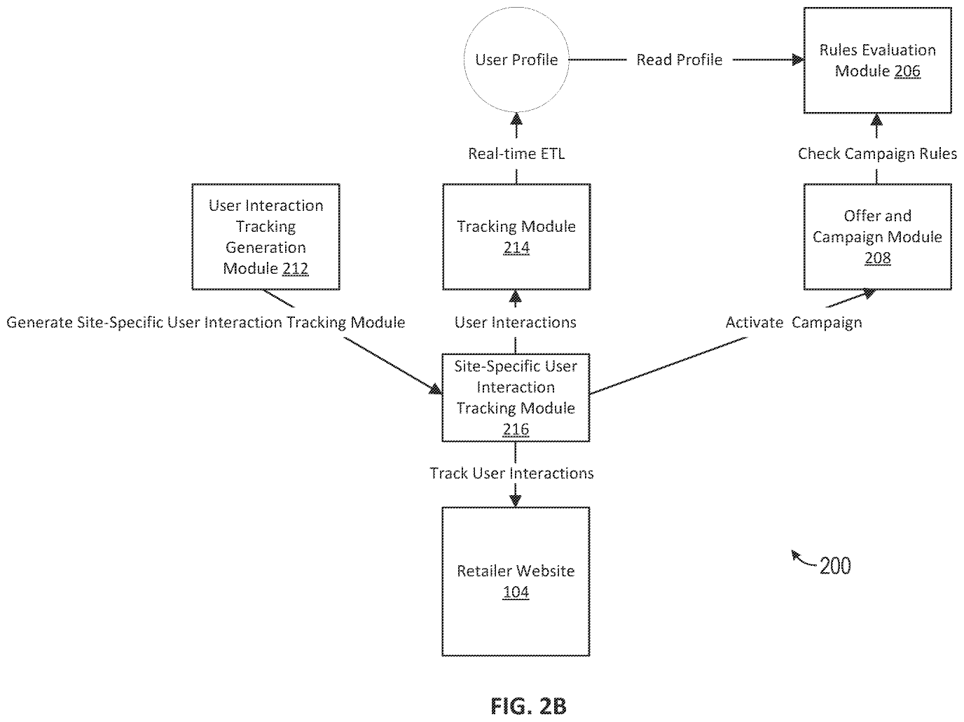

FIG. 2A depicts components of the personalized offer and information system 108 in some embodiments. The personalized offer and information system 108 may include a communication module 202, a product recommendation module 204, a rules evaluation module 206, an offer and campaign module 208, and a user profile module 210. The personalized offer and information system 108 may further include a user interaction tracking generation module 212, a tracking module 214, a site-specific user interaction tracking module 216, a user interface module 218, and an experimentation and optimization module 220. The personalized offer and information system 108 may further include a products datastore 222, a campaigns, offers, and rules datastore 224, a user interaction tracking configuration datastore 226, a user profiles datastore 228, a user interface templates datastore 230, and an experiments datastore 232.

The communication module 202 may send and/or receive requests and/or data between the personalized offer and information system 108 and any of the user device 102, the retailer website 104, and the retailer system 106. The communication module 202 may receive requests and/or data from any of the user device 102, the retailer website 104, and the retailer system 106. The communication module 202 may also send requests and/or data to any of the user device 102, the retailer website 104, and the retailer system 106.

The product recommendation module 204 may provide product recommendations. The product recommendation module 204 may receive product recommendation requests with parameters. The product recommendation module 204 may weight product recommendations with a given bias using the parameters. For example, the product recommendation module 204 may weight product recommendations towards products or services the user has selected for purchase, products or services that are frequently purchased together, and the best-selling products or services. The product recommendation module 204 may also use the parameters to provide category and brand restrictions and modifiers.

The rules evaluation module 206 may evaluate offers and a user profile to determine whether to display an offer to the user. The rules evaluation module 206 may optionally provide a relevance score based on the evaluation. The offer and campaign module 208 may receive campaign and offer definitions and provide campaigns and personalized offers included within campaigns. The user profile module 210 may create and/or update a user profile to include interactions of the user with a retailer website 104. The user profile module 210 may include data such as the current and historic shopping cart data, which is data on the products or services the user has selected for purchase either currently or historically and data such as current and historic sale data, which is data on the products or services the user has purchased currently or historically, in the user profile. The user profile may also include data such as current and historic landing pages of the user, current and historic segment records of the user, location of the user, weather at the location of the user, and prediction or predilection scores. A prediction or predilection score may be computed for the user that estimates the user's likelihood or propensity to purchase a product or service.

The user interaction tracking generation module 212 may generate a site-specific user interaction tracking module 216 for a retailer website 104. The tracking module 214 may receive user interactions from the site-specific user interaction tracking module 216 and provide user interactions to the user profile module 210 for creating and/or updating user profiles. The site-specific user interaction tracking module 216 may detect user interactions with the retailer website 104 and provide such user interactions to the tracking module 214. The site-specific user interaction tracking module 216 may also control the retailer website 104 so as to display the panel containing personalized offers and information and to hide the panel. The site-specific user interaction tracking module 216 may also control the retailer website 104 so as to display the visual indication of offers and to hide the visual indication of offers. The site-specific user interaction tracking module 216 may also detect offers that the user has interacted with.

The user interface module 218 may display or provide for display user interface elements. The user interface module 218 may use templates, stylesheets (for example, dynamic stylesheets), code (for example, NodeJS server-side code), and custom field definitions to create and/or configure various user interface elements.

The experimentation and optimization module 220 may, given a set of variations and an optimization model, attempt to identify winning variations and automatically weight winning variations. The experimentation and optimization module 220 may also do split tests with no automating winner selection. The experimentation and optimization module 220 may automatically optimize various types of data, such as sets of offer, and content within offers, such as images, titles, and a layout of offer components.

The products datastore 222 may include products data stored, accessed, and/or modified by the product recommendation module 204 or any of the other modules of the personalized offer and information system 108. The campaigns, offers, and rules datastore 224 may include campaigns, offers, and rules data stored, accessed, and/or modified by the offer and campaign module 208 or any of the other modules of the personalized offer and information system 108. The user interaction tracking configuration datastore 226 may include user interaction configuration data stored, accessed, and/or modified by the tracking module 214 or any of the other modules of the personalized offer and information system 108.

The user profiles datastore 228 may include user profile data stored, accessed, and/or modified by the user profile module 210 or any of the other modules of the personalized offer and information system 108. The user interface templates datastore 230 may include user interface templates data stored, accessed, and/or modified by the user interface module 218 or any of the other modules of the personalized offer and information system 108. The experiments datastore 232 may include experiments data stored, accessed, and/or modified by the experimentation and optimization module 220 or any of the other modules of the personalized offer and information system 108.

Each of the products datastore 222, the campaigns, offers, and rules datastore 224, the user interaction tracking configuration datastore 226, the user profiles datastore 228, the user interface templates datastore 230, and the experiments datastore 232 may include any number of data storage structures such as tables, databases, lists, and/or the like.

A module may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, and/or any combination. Software may be executed by one or more processors. Although a limited number of modules are depicted in FIG. 2A, there may be any number of modules. Further, individual modules may perform any number of functions, including functions of multiple modules as described herein.

FIG. 2B is a block diagram 200 depicting data flow between certain components of the personalized offer and information system 108 and a retailer website 104 that provides multiple products or services for sale in some embodiments. The user interaction tracking generation module 212 may generate the site-specific user interaction tracking module 216 and provide it to the retailer system 106 for installation on the retailer website 104. In some embodiments, the site-specific user interaction tracking module 216 may be generated and provided by a third-party system (for example, a system of an affiliate network). In some embodiments, the site-specific user interaction tracking module 216 may be or include a tag. The tag may include code, such as client-side JavaScript code, that executes on a user device 102. In such embodiments, the retailer system 106 may utilize a tag manager to install the tag or install the tag via a tag of a third-party system (for example, a system of an affiliate network) that is already installed on the retailer website 104. Each retailer website 104 may have a site-specific user interaction tracking module 216 that has its own unique identifier, such as a universally unique identifier (UUID).

The site-specific user interaction tracking module 216 may detect or track interactions of users with the retailer website 104 and send them to the tracking module 214. For example, the site-specific user interaction tracking module 216 may collect existing JavaScript variables (for example, data layers) and send them to the tracking module 214. The tracking module 214 may transform the user interactions data so that the user interactions data conforms to a common data schema for user profiles. For example, the tracking module 214 may create or update a user profile for a user accessing the retailer website 104 that includes the user interactions with the retailer website 104.

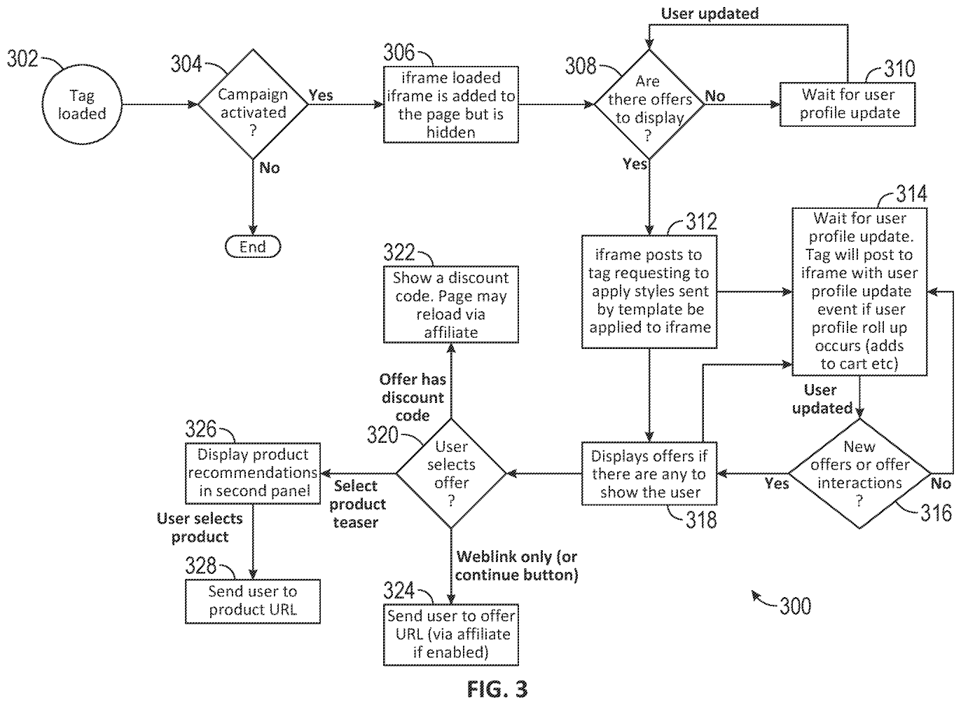

The site-specific user interaction tracking module 216 may provide the user interface elements for display for personalized offers and information. As discussed further herein, for example with reference to FIG. 3, the site-specific user interaction tracking module 216 may detect interactions of the user with the retailer website 104 and send them to the tracking module 214. The offer and campaign module 208 may determine that the user interactions satisfy one or more criteria for activating a campaign. The campaign may include multiple offers for one or more products or services of the multiple products or services that the retailer website 104 provides. If the offer and campaign module 208 determines that the user interactions satisfy the one or more criteria, the offer and campaign module 208 may activate the campaign. The site-specific user interaction tracking module 216 may detect further interactions of the user with the retailer website 104 and send them to the tracking module 214. The tracking module 214 may update the user profile for the user to include the further user interactions. The rules evaluation module 206 may evaluate the multiple offers for the one or more products or services of the multiple products or services and the user profile to identify one or more particular offers of the multiple offers to display to the user. As discussed further herein, for example, with reference to FIGS. 3-13, the site-specific user interaction tracking module 216 may utilize a user interface element, such as panel, which may be or include an HTML inline frame (an HTML iframe), to display the one or more particular offers of the multiple offers. As the user continues to interact with the retailer website 104, the site-specific user interaction tracking module 216 may detect the user interactions and send them to the tracking module 214. The user profile module 210 may update the user profile to include the user interactions. The rules evaluation module 206 may then evaluate the user profile and the multiple offers to identify offers to display to the user. If so, the 216 may send the offers to the user interface element for display.

As the user accesses products or services pages of the retailer website 104, the site-specific user interaction tracking module 216 may obtain information regarding products or services. The information may include product or service names, product or service prices. product or service images, and product or service stock level. The site-specific user interaction tracking module 216 may send the information regarding the products or services to the tracking module 214 for storage in the products datastore 222. The product recommendation module 204 may then access the stored information regarding the products or services to generate product recommendations. In some embodiments, the personalized offer and information system 108 populates the products datastore 222 using information from a third-party product feed provider.

FIG. 3 is a flow diagram depicting a method 300 for providing personalized offers and recommendations in some embodiments. The personalized offer and information system 108 may perform the method 300. The method 300 begins at step 302, where the retailer website 104 loads the site-specific user interaction tracking module 216, which may be or include, a tag as described herein. The site-specific user interaction tracking module 216 detects a first interaction of a user with the retailer website 104. The first interaction may include, for example, the user visiting a particular page, a page having particular content, a page having a particular event occur, and/or a particular query string in the HTML request. The first interaction may also include the user landing on any page of the retailer website 104, the user evidencing intent to exit the retailer website 104, the user spending a particular amount of time on the retailer website 104, the user using a copy function to copy a product or service name or description, the user inputting an invalid discount code, the user scrolling, and/or the user selecting text on a page of the retailer website 104. The first interaction may also include the user utilizing a particular user device 102 or browser, or a screen of the user device 102 having particular dimensions. The first interaction may also include the user being in a particular segment or group, as defined by the retailer, of the retailer website 104. Other types of first interactions will be apparent.

At step 304, the offer and campaign module 208 determines whether the first interaction satisfies one or more criteria for activating a campaign. A campaign may have a name, a description, a status, a visibility, which may be always visible or visible from a start date and time to an end date and time, and a theme. The theme determines the look and feel of offers and product recommendations provided to users and the look and feel of the user interface elements on the retailer website 104 (for example, the visual indication of offers and the panel in which offers are displayed). The retailer may define the theme so that offers, and the user interface clement in which offers are displayed, are consistent with a theme of the retailer website 104. Having the theme of the user interface element, the offers and product recommendations, and the visual indication of offers be consistent with the theme of the retailer website 104 may be important to the retailer. This is because the retailer may wish users to have a seamless and consistent experience in viewing products or services and viewing offers. Such a seamless and consistent experience may help to build trust and brand loyalty. The retailer may also determine whether to provide product recommendations for the campaign. If so, then certain offer types, such as discount code offers, may include product recommendations, and offer types such as product recommendations offers may be displayed to users of the retailer website 104.

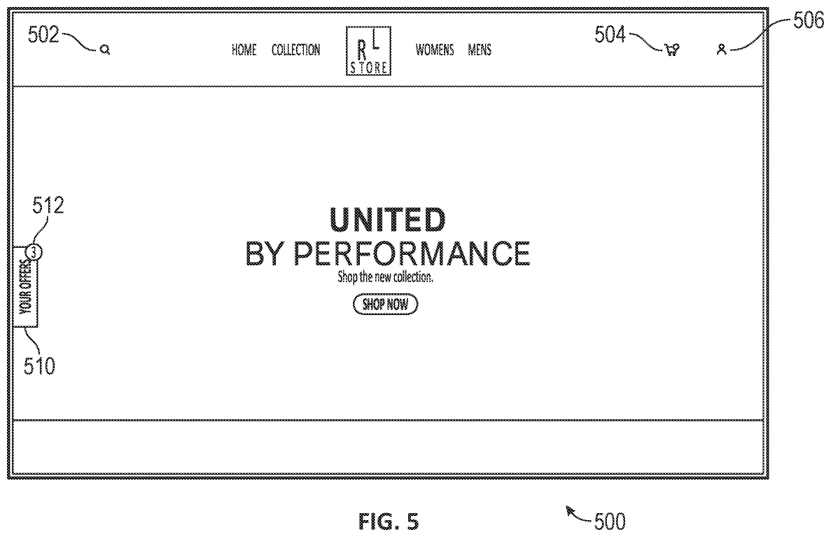

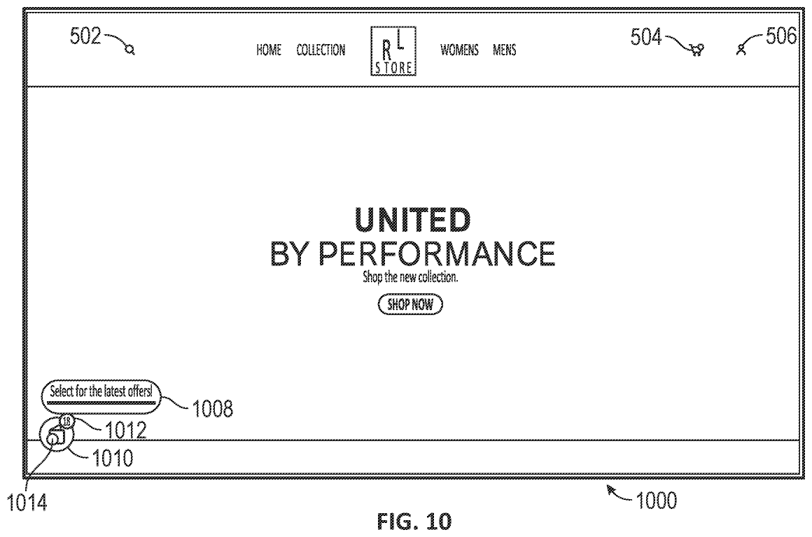

The campaign may include multiple offers for the multiple products or services that the retailer website 104 provides for sale. The offer and campaign module 208 may determine whether to provide the user with one or more offers of multiple offers for one or more products or services of the multiple products or services that the retailer website 104 provides for sale. If so, the method 300 continues at step 306, where the site-specific user interaction tracking module 216 causes the retailer website 104 to load a user interface element in which the user interface module 218 may display personalized offers and information. The site-specific user interaction tracking module 216 may cause the user interface module 218 to initially hide the user interface clement and to display a visual indication of offers. FIG. 5 and FIG. 10 depict example visual indications of offers with the user interface element hidden. When a user selects the visual indication of offers, the site-specific user interaction tracking module 216 may then cause the user interface module 218 to become visible and to display the user interface element in which offers are displayed. The site-specific user interaction tracking module 216 detects further interactions of the user with the retailer website 104. For example, the site-specific user interaction tracking module 216 may detect that the user has interacted with the retailer website 104 by viewing one or more products or services of the multiple products or services, selecting one or more products or services of the multiple products or services for purchase, or purchasing one or more products or services of the multiple products or services.

The user interactions may include attributes of the user device 102, such as a location of the user device 102 (for example, a city, country, a geofenced location, or a time zone). The user interactions may also include a day or time of the user device 102 (for example, a day of the month, a day of the week, a time of day). The user interactions may also include a weather of a location of the user device 102, attributes of the user device 102, a determined propensity or predilection of the user to purchase products or services, and other attributes of the user or user device 102 (for example, product engagement, user profile, user behavior, user segment or group). The user interactions may also be used to determine the amount of an offer. For example, a user with a very low predilection score or a very high predilection score may be provided with a minimal or low offer, because the user is either very unlikely to purchase or very likely to purchase. Similarly, the personalized offer and information system 108 may provide a user with an average predilection score with a good offer, because such a user may or may not purchase a product or service.

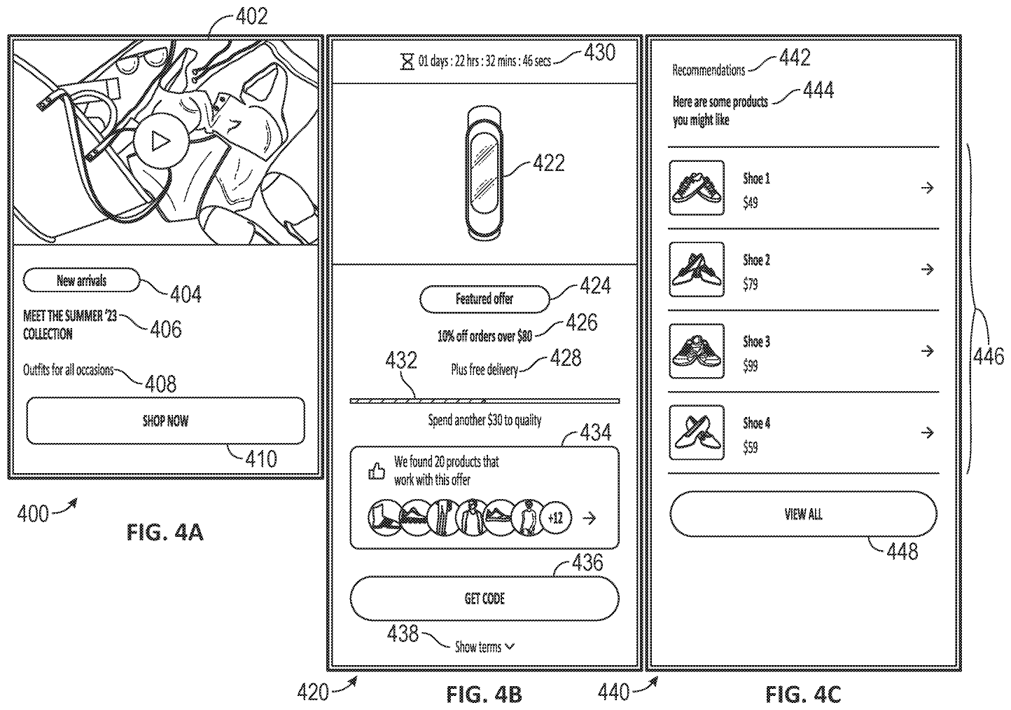

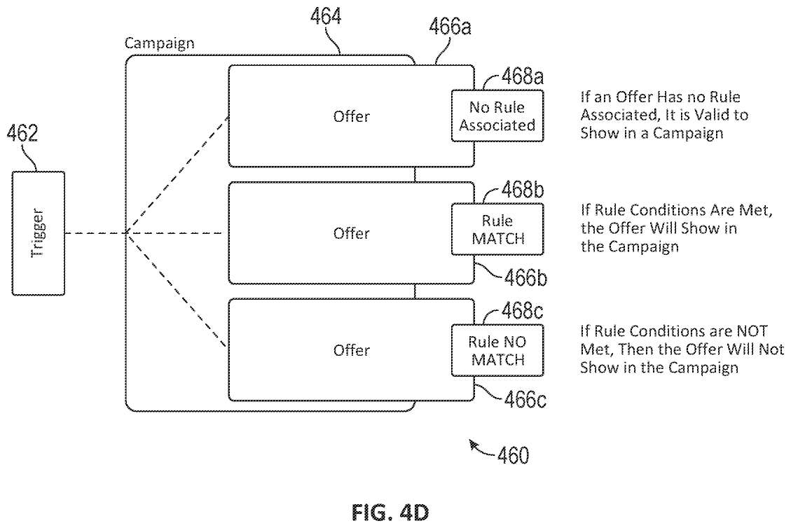

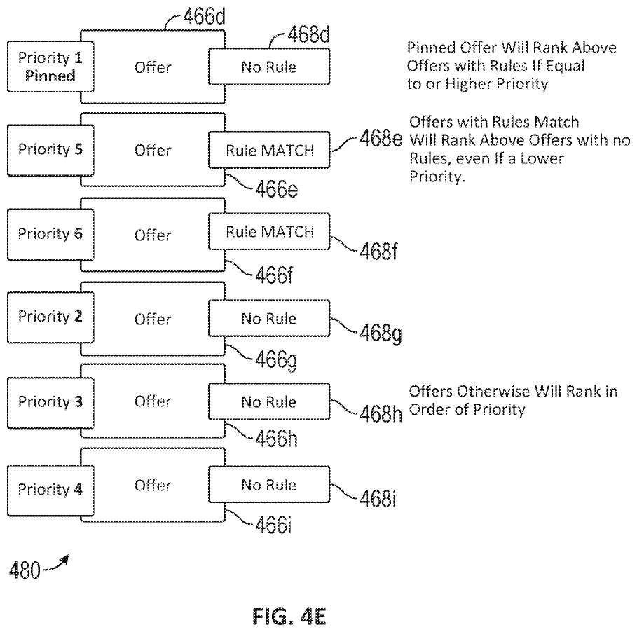

At step 308, the offer and campaign module 208 determines whether there are offers to display to the user. The personalized offer and information system 108 may provide several types of offers. FIGS. 4A-4C depict example user interfaces for personalized offers and information in some embodiments. One offer type is a link offer, also referred to as a weblink offer. FIG. 4A depicts an example user interface 400 for a link offer. A link offer is an offer type that provides information and/or directs the user to another page of the retailer website 104. The user interface 400 includes a video 402, a label 404, an offer title 406, an offer subtitle 408, and a button 410 providing a call to action (“Shop Now”) for the user. In various embodiments, the user interface 400 may include one or more images, graphics, animations, and/or the like (e.g., as an addition to or as an alternative to the video 402).

Another offer type is a discount code offer, also referred to as a voucher code offer. FIG. 4B depicts an example user interface 420 for a discount code offer. A discount code offer provides a code that the user may utilize to obtain a discount on one or more products or services. The user interface 420 includes an image 422 of a product, a label 424, an offer title 426, an offer subtitle 428, a countdown 430, a progress bar 432, a set of product recommendations 434, a button 436 to obtain the discount code, and a terms and conditions link 438. As discussed further herein, for example, with reference to FIGS. 4D-8, a discount code offer may have one or more rules associated with it that include conditions that have to be met in order for the user to obtain the discount code. The user interface module 218 may keep the button 436 inactive until the conditions are met, and activate the button 436 after the conditions are met. For example, the discount offer shown in FIG. 4B has the condition that the user has to spend $80 to get 10% off their order and free shipping. The countdown 430 may display a countdown timer indicating how much longer the discount code offer may be valid. The progress bar 432, which may also be referred to as a progress visual indicator, may display the progress of the user in meeting the conditions. The countdown 430 and the progress bar 432 may, alone or together, encourage the user to select products or services for purchase in order to obtain the discount code, which may further incentivize the user to purchase products or services.

Another offer type is a product recommendations offer. FIG. 4C depicts an example user interface 440 for a product recommendations offer. The user interface 440 includes an offer title 442, an offer subtitle 444, a group of recommended products 446, and a button 448 to view all recommended products. Each of the recommended products includes an image, a title, and a price. In some embodiments, the user may select a recommended product to view the page for the recommended product or add the selected product to a cart. As shown in FIG. 4B, a set of one or more product recommendations may also be included in a discount code offer. Although not shown in FIG. 4A, a link offer may similarly include a set of one or more product recommendations.

FIG. 4D is a block diagram 460 depicting a trigger 462, a campaign 464, offers 466, and rules 468 in some embodiments. A campaign 464 may have to be activated, by one or more criteria being met (also referred to as a trigger), in order for the offers 466 of the campaign 464 to be displayed. A campaign 464 may include one or more offers 466, shown individually as offers 466a-c. An offer may have one or more rules 468, shown individually as rules 468a-c. associated with it. The offer 466a has no associated rules, as indicated by 468a. Since the offer 466a has no associated rules, the offer 466a is valid to show in the campaign 464. Offer 466b has the rule 468b associated with it. The rule 468b may have one or more associated conditions, and if the associated conditions are met, then the offer 466b will show in the campaign 464. Offer 466c has the rule 468c associated with it. The rule 468c may have one or more associated conditions, and if the associated conditions are not met, then the offer 466c will not show in the campaign 464. If no offers 466 can be shown in the campaign 464, because no offers are included in the campaign or because the conditions of the associated rules are not met, then the campaign 464 will not display even if the campaign 464 is activated.

An offer 466 may also be set to persist once shown. If so, then once the conditions of the associated rule 468 have been met and the offer 466 has been shown, then the offer 466 will continue to be shown to the user. For example, if an offer 466 has a rule 468 with conditions specifying that the offer 466 is to be displayed if the value of the products or services in a shopping cart of the user is between a first amount (for example, $50) and a second amount (for example, $100), then the offer 466 will continue to be shown to the user even if the value dips below the first amount or rises above the second amount. If the offer is not set to persist once shown, then the offer will not display if the value dips below the first amount or rises above the second amount.

Offers 466 may also have priorities. For example, an offer 466 may have a priority on a scale of 1-20, with 1 being the highest priority and 20 being the lowest priority. FIG. 4E is a block diagram 480 depicting priorities of offers in some embodiments. Offer 466d has a priority of one and is pinned but has no associated rules, as indicated by 468d. A pinned offer will rank above offers with rules if the pinned offer has a priority that is equal to or higher than the priorities of offers with rules. Accordingly, offer 466d will rank above offer 466e, which has a matching rule 468e, and offer 466f, which also has a matching rule 468f. Offers with associated rules whose conditions match will rank above offers with no associated rules even if they are lower priority. Accordingly, offers 466e and 466f will rank above offer 466g (which has no associated rule, as indicated by 468g), offer 466h (which has no associated rule, as indicated by 468h), and offer 466i (which has no associated rule, as indicated by 468i). Offers without rules, such as offer 466g. offer 466h, and offer 466i, will rank in order of priority. Accordingly offer 466g, which has a priority of 2, ranks above offer 466h, which has a priority of 3, and also above offer 466i, which has a priority of 4. The user interface module 218 uses the rank of offers to order the offers for display in the user interface element.

Returning to step 308 of FIG. 3, the offer and campaign module 208 evaluates the multiple offers and the user profile to identify one or more particular offers of the multiple offers to display to the user. The offer and campaign module 208 may identify one or more rules associated with the multiple offers. The one or more rules may each have one or more conditions. The offer and campaign module 208 may evaluate the one or more rules and the user profile to determine if the one or more conditions are met. For example, a rule may include the condition that a value of products or services the user has selected for purchase has to exceed a threshold amount. An offer that has that rule will show only if the rule conditions are met. As another example, a rule may include the conditions that the user is located in a specific geographic area and that a forecasted maximum temperature for the specific geographic area is not to exceed a threshold temperature. An offer that has that rule will only show if both rule conditions are met. An offer may not have any rules associated with it. As discussed with reference to, for example, FIGS. 4D and 4E, such an offer will be shown to the user if the campaign is activated.

If the offer and campaign module 208 determines that there are no offers to display, the method 300 continues to step 310, where the offer and campaign module 208 waits for an update to occur to the user profile. If the user profile module 210 updates the user profile, then the method returns to step 308. If the offer and campaign module 208 determines that there are offers to display, then the method 300 continues to step 312. At step 312, the user interface module 218 posts to the site-specific user interaction tracking module 216 requesting to apply styles sent by the user interface module 218 be applied to the user interface element. The styles may define the theme of the user interface element and the offers displayed within the user interface element. After step 312, the method 300 may continue to step 314 or step 318.

At step 318, the user interface module 218 displays offers if there are any to show to the user. FIG. 5 depicts an example user interface 500 displaying a visual indication of offers in some embodiments, with the user interface element that displays the offers initially hidden. The user interface 500 includes a search icon 502, a shopping cart icon 504, and an account profile icon 506 that allows the user to sign in to the retailer website 104. The user interface 500 also includes a visual indication 510, also referred to as a widget, of offers for the user. The visual indication 510 includes a counter 512 with the number three, indicating that there are three offers for the user. The user may select the visual indication 510, which causes the user interface module 218 to display the offers. The personalized offer and information system 108 may provide personalized offers and information to users of the retailer website 104 who are signed in and to users who are not signed in. For users who are not signed in, the personalized offer and information system 108 may utilize privacy-aware cookies or other techniques (for example, browser fingerprinting) to identify the users and provide the users with personalized offers and information. In this fashion the non-signed in users may see the same personalized offers and information across user sessions, even if such sessions are spaced far apart in time. For example, a user may see a personalized offer on the retailer website 104, close their browser, return to the retailer website 104 at a later time, and see the same personalized offer.

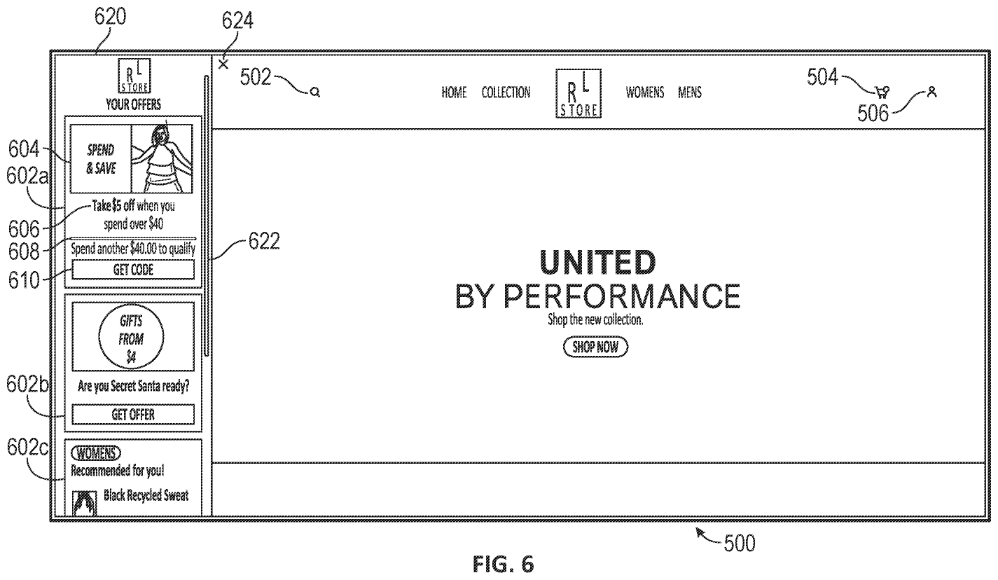

FIG. 6 depicts the example user interface 500 of FIG. 5 with a panel 620 that displays offers in some embodiments. The user interface module 218 displays the panel 620 after the user has selected the visual indication 510 in the user interface 500. The panel 620 includes multiple offers, which appear as individual cards. If there are more offers for the user than can be shown in the panel 620, the panel 620 includes a scroll bar 622 that allows the user to scroll through all the offers in the panel 620. The panel 620 includes an offer 602a, an offer 602b, and an offer 602c. The offer 602a, which is a discount code offer, includes an image 604, a title 606, a progress bar 608, and a button 610 labeled “Get Code”. The user may not be able to obtain the discount code until the user has selected for purchase $40 worth of products or services. Until then, the button 610 may not be selectable. Once the user has reached the $40 threshold, the button 610 may become selectable and cause the user interface module 218 to show the discount code to the user upon selection. The user may close the panel 620 by selecting a close icon 624 proximate to the panel. If the user closes the panel 620, the user interface module 218 may show the visual indication 510 with the counter indicating the number of offers available to the user. For example, the user may wish to close the panel 620 so that the user may view products or services, select products or services for purchase, or purchase products or services.

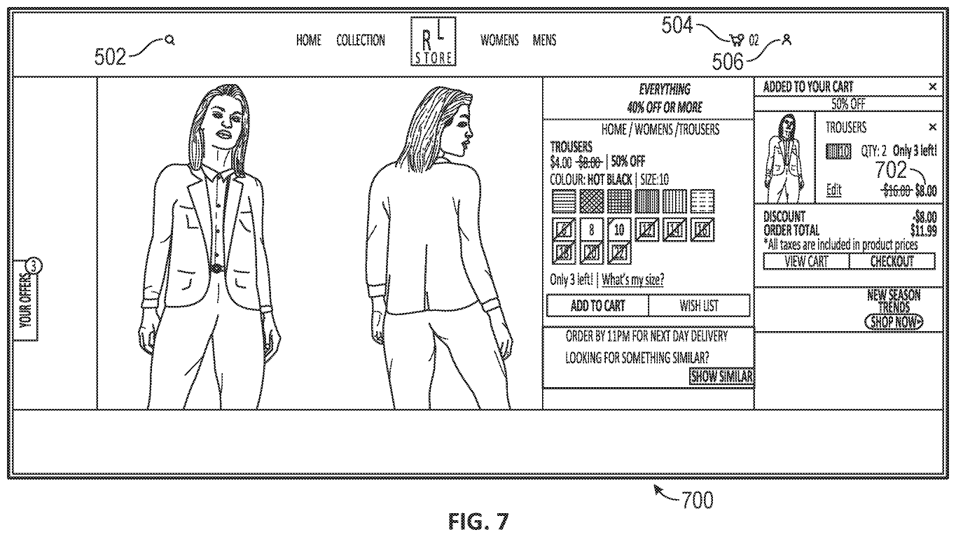

FIG. 7 depicts another example user interface 700 showing a product selected for purchase in some embodiments. In FIG. 7, the user has selected two pairs of women's trousers for purchase. The two pairs of women's trousers, which are discounted by 50%, total $8.00, as indicated by total 702. The site-specific user interaction tracking module 216 detects the user selecting the two pairs of women's trousers for purchase, sends the user interaction to the tracking module 214, and the user profile module 210 updates the user profile to include the user interaction.

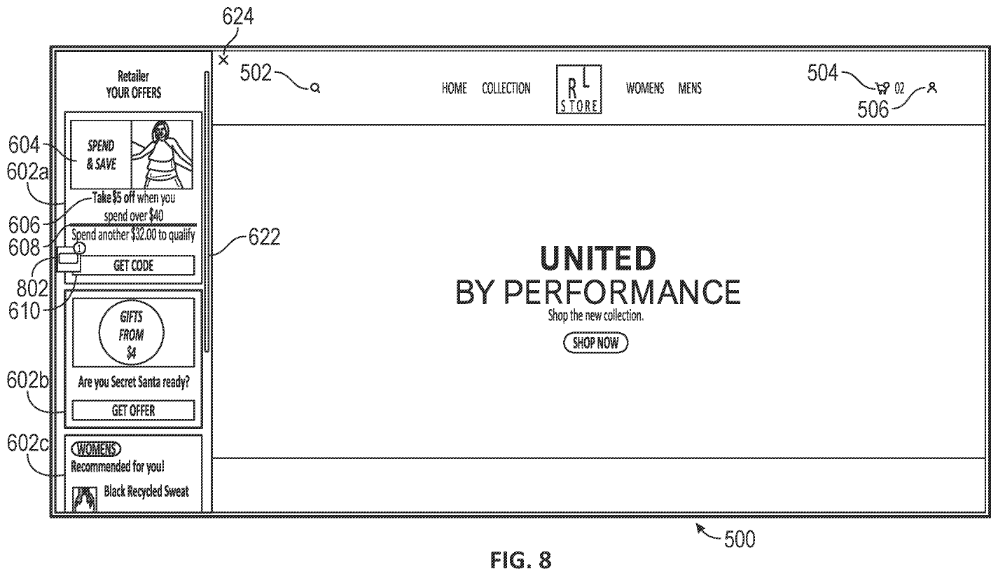

FIG. 8 depicts the example user interface 500 of FIG. 5, with the panel 620 displaying the offer 602a having a progress bar 608 that has been updated in some embodiments. The user interface module 218 has updated the progress bar 608 to show the progress the user has made towards obtaining or unlocking the discount code. The user interface module 218 has also updated the text below the progress bar 608 from “Spend another $40.00 to qualify” to “Spend another $32.00 to qualify.” The progress bar 608 informs the user of their progress in unlocking the discount code. Accordingly, the progress bar 608 may incentivize or encourage the user to select enough products or services for purchase so as to be able to obtain the discount code. Such encouragement may increase conversion rates and/or average order value (AOV) of the retailer operating the retailer website 104.

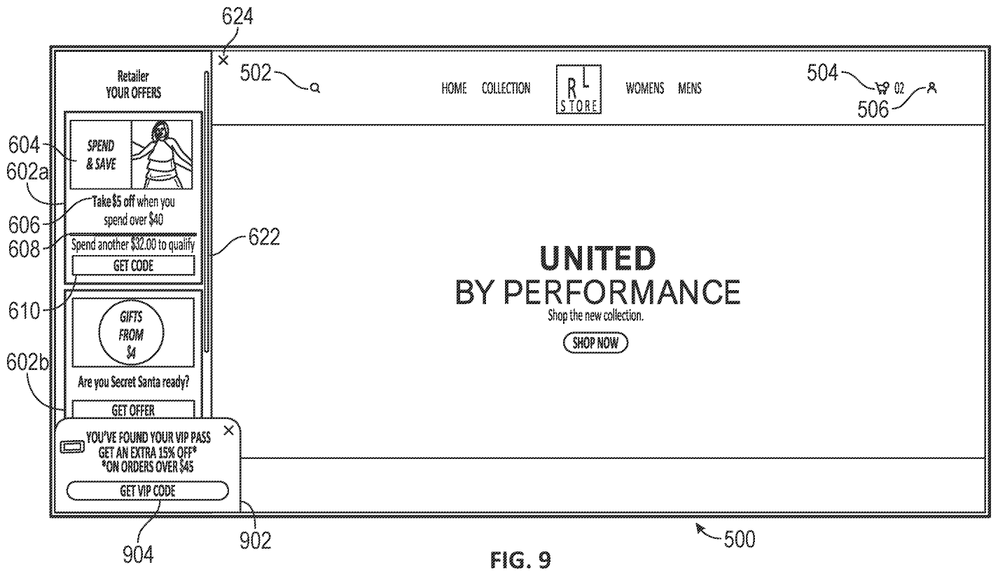

The site-specific user interaction tracking module 216 sent the user interactions of selecting the two pairs of women's trousers for purchase to the tracking module 214, which results in the user profile module 210 updating the user profile of the user. Since there has been a user profile update, the user has become eligible for an additional offer, a visual indication of which is shown as an icon 802. The icon 802 includes a counter with the number one in it, indicating that the user has qualified for one additional offer. FIG. 9 depicts the example user interface 500 of FIG. 5, displaying an additional offer 902 in some embodiments. The additional offer 902 includes text indicating that the user is eligible for an additional 15% discount on orders over $45. The offer also includes a button 904 labeled “Get VIP Code.” The button 904 may not be selectable until the user has selected $45 worth of products or services for purchase. In some embodiments, the additional offer 902 is part of an experiment that the experimentation and optimization module 220 performs to see if the user increases the value of the products or services the user selects for purchase and ultimately purchases.

Returning to the method 300 of FIG. 3, at step 314, if a user profile update has occurred, the site-specific user interaction tracking module 216 sends additional offers or information to the panel (as depicted in FIGS. 7-9). At step 316, if there are no new offers or offer interactions, the method 300 returns to step 314. If there are new offers or offer interactions, the method continues to step 318. After step 318, the method may return to step 314, or to step 320. At step 320, the site-specific user interaction tracking module 216 determines if the user selects an offer. If the offer is a discount code offer and the user selects it, the method continues to step 322, where the user interface module 218 displays the discount code. If the offer is a link offer type, if the user selects it, the method 300 continues at step 324 where the user interface module 218 sends the user to the offer URL. If the offer is a product recommendations offer, or if it is another type of offer that includes product recommendations, and the user selects product recommendations, the method continues at step 326, where the user interface module 218 displays product recommendations. If the user selects a product, the user interface module 218 sends the user to the product URL at step 328.

FIG. 10 depicts another example user interface 1000 displaying another visual indication 1010 of offers in some embodiments. The visual indication 1010, also referred to as a widget, includes an icon 1014 of a wallet, a counter 1012 with a number of offers available to the user, and text 1008 indicating to the user that the user may select the visual indication 1010 to see the offers available to the user. Various aspects of the visual indication 1010 may be configurable, such as the icon 1014, colors, placement, and size. In some embodiments, the visual indication 1010 includes the text 1008 and not the icon 1014. In some embodiments, the visual indication 1010 includes both the text 1008 and the icon 1014. In some embodiments, the visual indication 1010 includes the icon 1014 and not the text 1008. The user may select the visual indication 1010, which causes the user interface module 218 to display the offers in a user interface clement, which is initially hidden.

The user interface module 218 may display the visual indication 1010 anywhere on the user interface 1000. For example, the user interface module 218 may display the visual indication 1010 proximate to the shopping cart icon 504 so that it is always visible to the user. The use of a wallet icon may provide several advantages. First, the wallet icon may convey to users that it is a hub for offers, marketing messages and contextual recommendations. Accordingly, the wallet icon may increase offer and/or message engagement and help users to trust the retailer more. Second, the site-specific user interaction tracking module 216 may dynamically update the wallet icon every time a new offer becomes available to the user by incrementing a counter of the wallet to indicate that there is a new offer available to the user. Accordingly, the wallet icon may increase the likelihood that the user may purchase products or services, thereby increasing the average order value (AOV) of the retailer.

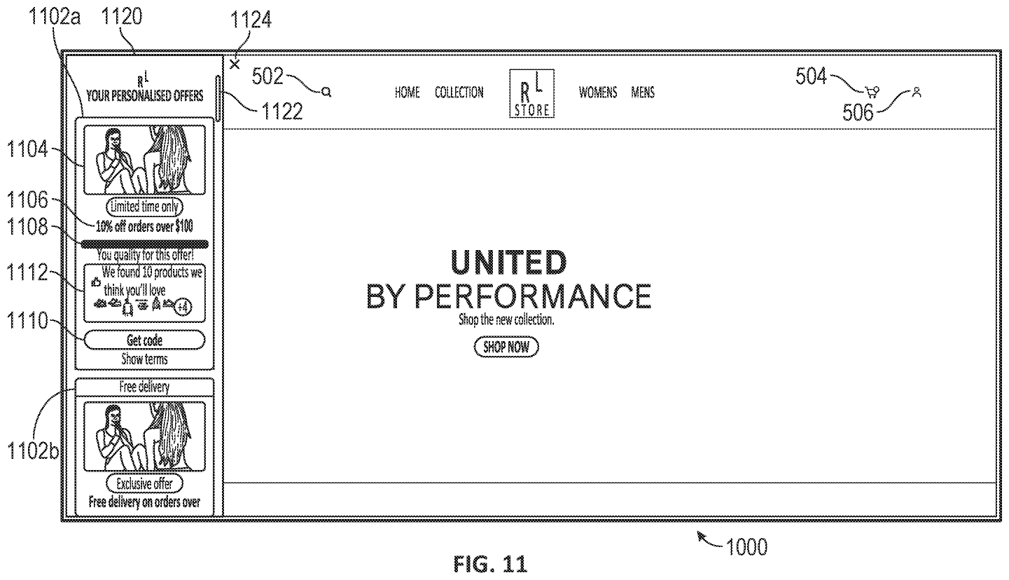

FIG. 11 depicts the example user interface 1000 of FIG. 10 with a panel 1120 that displays offers in some embodiments. The user interface module 218 displays the panel 1120 after the user has selected the visual indication 1010 in the user interface 1000. The panel 1120 includes multiple offers, which appear as individual cards. If there are more offers for the user than can be shown in the panel 1120, the panel 1120 includes a scroll bar 1122 that allows the user to scroll through all the offers. The panel 1120 includes an offer 1102a and an offer 1102b. The offer 1102a, which is a discount code offer, includes an image 1104, a title 1106, a progress bar 1108, and a button 1110 labeled “Get Code.” The user may close the panel 1120 by selecting a close icon 1124 proximate to the panel 1120. If the user closes the panel 1120, the user interface module 218 may show the visual indication 1010 with the counter indicating the number of offers available to the user. For example, the user may wish to close the panel 1120 so that the user may view products or services, select products or services for purchase, or purchase products or services. The offer 1102a includes a set of product recommendations 1112.

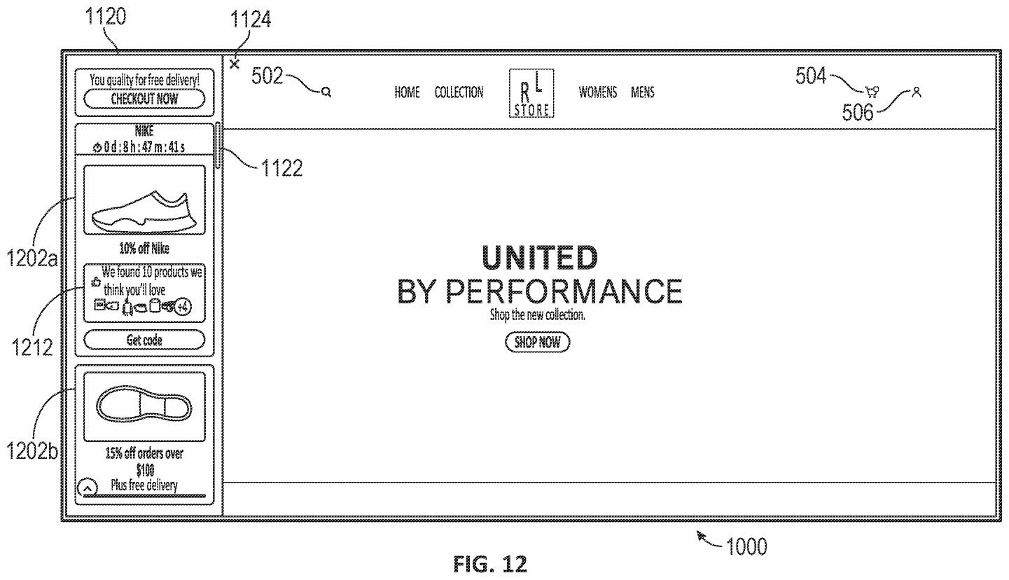

FIG. 12 depicts the example user interface 1000 of FIG. 10, with the panel 1120 displaying an offer 1202a and an offer 1202b in some embodiments. The offer 1202a also includes a set of product recommendations 1212.

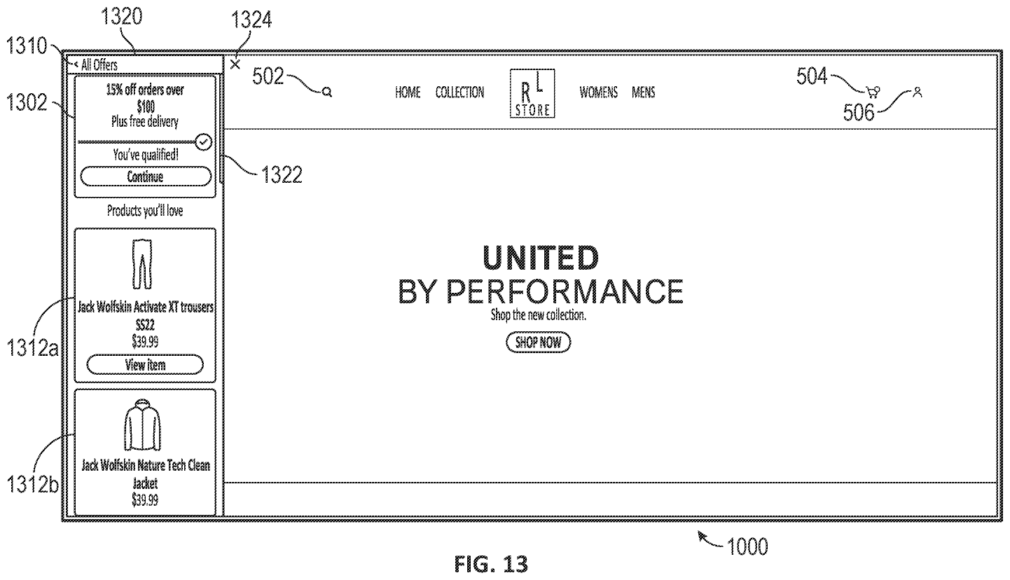

FIG. 13 depicts the example user interface 1000 of FIG. 10 displaying product recommendations in a panel 1320 in some embodiments. The user interface module 218 may display the panel 1320 if the user selects a set of product recommendations, such as the set of product recommendations 1112 in the offer 1102a of FIG. 11 or the set of product recommendations 1212 in the offer 1202a of FIG. 12. The user interface module 218 may also display the panel 1320 if the user selects a “View All” button in a product recommendations offer, such as the button 448 of FIG. 4C.

The panel 1320 includes a first recommended product 1312a and a second recommended product 1312b. The panel 1320 also includes an offer 1302. The user may scroll through the offers and the recommended products using a scroll bar 1322 and close the panel 1320 using a close icon 1324 proximate to the panel 1320. The panel 1320 also includes a text link 1310 with the text “<All offers.” If the user selects the text link 1310, the user interface module 218 will close the panel 1320 and return to the previous panel the user was viewing, which may be the panel 1120 of FIG. 11 or the panel 1120 of FIG. 12. The user may view a recommended product page by selecting the first recommended product 1312a or the second recommended product 1312b.

FIG. 14 depicts a block diagram of an example digital device 1400 according to some embodiments. The digital device 1400 is shown in the form of a general-purpose computing device. The digital device 1400 includes at least one processor 1402, RAM 1404, communication interface 1406, input/output device 1408, storage 1410, and a system bus 1412 that couples various system components including storage 1410 to the at least one processor 1402. A system, such as a computing system, may be or include one or more of the digital device 1400.

System bus 1412 represents one or more of any of several types of bus structures, including a memory bus or memory controller, a peripheral bus, an accelerated graphics port. and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1400 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1402 is configured to execute executable instructions (for example, programs). In some embodiments, the at least one processor 1402 comprises circuitry or any processor capable of processing the executable instructions.

In some embodiments, RAM 1404 stores programs and/or data. In various embodiments, working data is stored within RAM 1404. The data within RAM 1404 may be cleared or ultimately transferred to storage 1410, such as prior to reset and/or powering down the digital device 1400.

In some embodiments, the digital device 1400 is coupled to a network, such as the communication network 110, via communication interface 1406. Still yet, the retailer website 104, the retailer system 106, and/or the personalized offer and information system 108 can communicate with one or more networks such as a local area network (LAN), a general wide area network (WAN), and/or a public network (for example, the Internet).

In some embodiments, input/output device 1408 is any device that inputs data (for example, mouse, keyboard, stylus, sensors, etc.) or outputs data (for example, speaker, display, virtual reality headset).

In some embodiments, storage 1410 can include computer system readable media in the form of non-volatile memory, such as read only memory (ROM), programmable read only memory (PROM), solid-state drives (SSD), flash memory, and/or cache memory. Storage 1410 may further include other removable/non-removable, volatile/non-volatile computer system storage media. By way of example only, storage 1410 can be provided for reading from and writing to a non-removable, non-volatile magnetic media. The storage 1410 may include a non-transitory computer-readable medium, or multiple non-transitory computer-readable media, which stores programs or applications for performing functions such as those described herein with reference to, for example, FIG. 2A. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1412 by one or more data media interfaces. As will be further depicted and described below, storage 1410 may include at least one program product having a set (for example, at least one) of program modules that are configured to carry out the functions of embodiments of the invention. In some embodiments, RAM 1404 is found within storage 1410.

Programs/utilities, having a set (at least one) of program modules, such as the personalized offer and information system 108, may be stored in storage 1410 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the digital device 1400. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled”, “couplable”, “operably coupled”, “communicably coupled” and the like to other components. Such description or illustration should be understood as indicating that such components may cooperate or interact with each other, and may be in direct or indirect physical, electrical, or communicative contact with each other.

Components may be described or illustrated as “configured to”, “adapted to”, “operative to”, “configurable to”, “adaptable to”, “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services”, and “providing products and services.”

It may be apparent that various modifications may be made, and other embodiments may be used without departing from the broader scope of the discussion herein. For example, although a retailer may be described herein, aspects of the disclosure are applicable to any entity that provides products or services for purchase or lease, such as manufacturers, wholesalers, and distributors. As another example, although users browsing retailer websites may be described herein, aspects of the disclosure are applicable to users accessing any software by which products or services are sold or leased, such as mobile and/or desktop apps. As a further example, the user interface element in which personalized offers and product recommendations are displayed may be positioned proximate to the bottom side or the right side of a user interface. Therefore, these and other variations upon the example embodiments are intended to be covered by the disclosure herein.

1. A non-transitory computer-readable medium comprising executable instructions, the executable instructions being executable by one or more processors to perform a method, the method comprising:
detecting, using a tag associated with a website providing multiple products for sale on multiple pages of the website, a first interaction of a user with the website, the website operated by a first entity, the tag provided by a second entity distinct from the first entity, the website having a first theme;
determining that the first interaction of the user with the website satisfies one or more criteria for activating a campaign to provide the user with one or more offers of multiple offers for one or more products of the multiple products, the campaign including the multiple offers for the one or more products of the multiple products, the campaign and the multiple offers for the one or more products of the multiple products defined by the first entity and provided to the second entity;
activating the campaign;
detecting, using the tag, second interactions of the user with first pages of the website, the second interactions including at least one of the user viewing one or more products of the multiple products, the user selecting one or more products of the multiple products for purchase, and the user purchasing one or more products of the multiple products;
updating a profile of the user to include the second interactions of the user with the first pages of the website;
evaluating the multiple offers for the one or more products of the multiple products and the profile of the user to identify one or more particular offers of the multiple offers to display to the user;
identifying one or more particular offers of the multiple offers for the one or more products of the multiple products to display to the user;
receiving a second theme defined by the first entity, the second theme consistent with the first theme of the website;
generating, based on the second theme, a template and a stylesheet;
generating a visual indication of the one or more particular offers;
applying, using the template, the stylesheet to the visual indication of the one or more particular offers, such that the visual indication of the one or more particular offers has the second theme that is consistent with the first theme of the website;
displaying to the user the visual indication of the one or more particular offers on second pages of the website, the visual indication having the second theme that is consistent with the first theme of the website, wherein displaying to the user the visual indication of the one or more particular offers on the second pages of the website includes displaying to the user the visual indication of the one or more particular offers as a persistent overlay on the second pages of the website;
receiving a selection by the user of the visual indication;
generating a panel to contain the one or more particular offers and the one or more particular offers;
applying, using the template, the stylesheet to the panel to contain the one or more particular offers and the one or more particular offers, such that the panel to contain the one or more particular offers and the one or more particular offers have the second theme that is consistent with the first theme of the website; and
displaying to the user the one or more particular offers in the panel on the website, the panel and the one or more particular offers having the second theme that is consistent with the first theme of the website.

2. The non-transitory computer-readable medium of claim 1, the method further comprising identifying one or more rules associated with the multiple offers for the one or more products of the multiple products, at least one rule of the one or more rules including one or more conditions, and wherein:
evaluating the multiple offers for the one or more products of the multiple products and the profile of the user to identify one or more particular offers of the multiple offers to display to the user includes evaluating the one or more rules and the profile of the user to determine if the one or more conditions of the at least one rule are met, and
identifying one or more particular offers of the multiple offers for the one or more products of the multiple products to display to the user includes determining that the one or more conditions of the at least one rule are met.

3. The non-transitory computer-readable medium of claim 1, the method further comprising identifying one or more priorities associated with the one or more particular offers, wherein displaying to the user the one or more particular offers in a panel on the website includes displaying the one or more particular offers in a panel in an order based on the one or more priorities associated with the one or more particular offers.

4. The non-transitory computer-readable medium of claim 1, wherein a particular offer of the one or more particular offers includes a threshold value of products to be selected for purchase to be met to qualify for the particular offer, and the method further comprising:
displaying to the user a progress visual indicator in the particular offer, the progress visual indicator indicating a progress of the user in qualifying for the particular offer;
determining that the user has selected one or more products of the multiple products for purchase;
updating the progress visual indicator to obtain an updated progress visual indicator, the updated progress visual indicator indicating the progress of the user in qualifying for the particular offer; and
displaying the updated progress visual indicator in the particular offer.

5. The non-transitory computer-readable medium of claim 1 wherein the panel includes an inline frame that is hidden by the website prior to displaying to the user the one or more particular offers in a panel on the website, the method further comprising causing the website to display the inline frame after receiving a selection by the user of the visual indication, and wherein displaying to the user the one or more particular offers in a panel on the website includes displaying to the user the one or more particular offers in the inline frame.

6. The non-transitory computer-readable medium of claim 1 wherein the one or more particular offers include at least one of a discount code for one or more products of the multiple products and a link to one or more products of the multiple products.

7. The non-transitory computer-readable medium of claim 1 wherein the one or more particular offers include one or more recommendations for one or more products of the multiple products, wherein the one or more recommendations are based on the second interactions of the user with the website, the second interactions including the user viewing one or more products of the multiple products.

8. The non-transitory computer-readable medium of claim 7 wherein the second interactions include the user viewing one or more products of the multiple products and the method further comprising:
obtaining information regarding the one or more products of the multiple products, the information including at least one of one or more names, one or more prices, and one or more images of the one or more products of the multiple products;
storing the information regarding the one or more products of the multiple products in a products datastore;
accessing the products datastore to generate the one or more recommendations for one or more products of the multiple products; and
generating the one or more recommendations for the one or more products of the multiple products.

9. The non-transitory computer-readable medium of claim 1 wherein the tag includes executable instructions being executable by one or more processors of a digital device of the user.

10. A method comprising:
detecting a first interaction of a user with a website, the website providing multiple products or services for sale on multiple pages of the website, the website having a first theme;
determining that the first interaction of the user with the website satisfies one or more criteria for activating a campaign to provide the user with one or more offers of multiple offers for one or more products or services of the multiple products or services, the campaign including the multiple offers for the one or more products or services of the multiple products or services;
activating the campaign;
detecting second interactions of the user with first pages of the website, the second interactions including at least one of the user viewing one or more products or services of the multiple products or services, the user selecting one or more products or services of the multiple products or services for purchase, and the user purchasing one or more products or services of the multiple products or services;
updating a profile of the user, the profile including the second interactions of the user with the first pages of the website;
evaluating the multiple offers for the one or more products or services of the multiple products or services and the profile of the user to identify one or more particular offers of the multiple offers to display to the user;
identifying one or more particular offers of the multiple offers for the one or more products or services of the multiple products or services included in the campaign to display to the user;
receiving a second theme, the second theme consistent with the first theme of the website;
generating, based on the second theme, a template and a stylesheet;
generating a visual indication of the one or more particular offers;
applying, using the template, the stylesheet to the visual indication of the one or more particular offers, such that the visual indication of the one or more particular offers has the second theme that is consistent with the first theme of the website;
displaying the visual indication of the one or more particular offers on second pages of the website, the visual indication having the second theme that is consistent with the first theme of the website, wherein displaying the visual indication of the one or more particular offers on the second pages of the website includes displaying the visual indication of the one or more particular offers as a persistent overlay on the second pages of the website;
receiving a selection by the user of the visual indication;
generating the one or more particular offers;
applying, using the template, the stylesheet to the one or more particular offers, such that the one or more particular offers have the second theme that is consistent with the first theme of the website; and
displaying the one or more particular offers on the website, the one or more particular offers having the second theme that is consistent with the first theme of the website.

11. The method of claim 10 wherein displaying the one or more particular offers on the website includes displaying the one or more particular offers in a panel on the website.

12. The method of claim 11 wherein the panel includes an inline frame that is hidden by the website prior to displaying to the user the one or more particular offers in a panel on the website, the method further comprising causing the website to display the inline frame after receiving a selection by the user of the visual indication, and wherein displaying to the user the one or more particular offers in a panel on the website includes displaying to the user the one or more particular offers in the inline frame.

13. The method of claim 10, further comprising identifying one or more rules associated with the multiple offers for the one or more products or services of the multiple products or services, at least one rule of the one or more rules including one or more conditions, and wherein:
evaluating the multiple offers for the one or more products or services of the multiple products or services and the profile of the user to identify one or more particular offers of the multiple offers to display to the user includes evaluating the one or more rules and the profile of the user to determine if the one or more conditions of the at least one rule are met, and
identifying one or more particular offers of the multiple offers for the one or more products or services of the multiple products or services to display to the user includes determining that the one or more conditions of the at least one rule are met.

14. The method of claim 10, further comprising identifying one or more priorities associated with the one or more particular offers, wherein displaying to the user the one or more particular offers on the website includes displaying the one or more particular offers in a panel on the website in an order based on the one or more priorities associated with the one or more particular offers.

15. The method of claim 10 wherein a particular offer of the one or more particular offers includes a threshold value of products or services to be selected for purchase to be met to qualify for the particular offer, and the method further comprising:
displaying to the user a progress visual indicator in the particular offer, the progress visual indicator indicating a progress of the user in qualifying for the particular offer;
determining that the user has selected one or more products or services of the multiple products or services for purchase;
updating the progress visual indicator to obtain an updated progress visual indicator, the updated progress visual indicator indicating the progress of the user in qualifying for the particular offer; and
displaying the updated progress visual indicator in the particular offer.

16. The method of claim 10 wherein the one or more particular offers include at least one of a discount code for one or more products or services of the multiple products or services and a link to one or more products or services of the multiple products or services.

17. The method of claim 10 wherein the one or more particular offers include one or more recommendations for one or more products or services of the multiple products or services, wherein the one or more recommendations are based on the second interactions of the user with the website, the second interactions including the user viewing one or more products or services of the multiple products or services.

18. The method of claim 17 wherein the second interactions include the user viewing one or more products of the multiple products, and the method further comprising:
obtaining information regarding the one or more products or services of the multiple products or services, the information including at least one of one or more names, one or more prices, and one or more images of the one or more products or services of the multiple products or services;
storing the information regarding the one or more products or services of the multiple products or services in a products datastore;
accessing the products datastore to generate the one or more recommendations for one or more products or services of the multiple products or services; and
generating the one or more recommendations for the one or more products or services of the multiple products or services.

19. The method of claim 10 wherein detecting the first interaction of the user with the website includes detecting, using a tag associated with the website, the first interaction of the user with the website, detecting second interactions of the user with the website includes detecting, using the tag, the second interactions of the user with the website, and the tag includes executable instructions being executable by one or more processors of a digital device of the user.

20. A system comprising at least one processor and memory containing instructions, the instructions being executable by the at least one processor to:
detect a first interaction of a user with a website, the website providing multiple products or services for sale on multiple pages of the website, the website having a first theme;
determine that the first interaction of the user with the website satisfies one or more criteria for activating a campaign to provide the user with one or more offers of multiple offers for one or more products or services of the multiple products or services, the campaign including the multiple offers for the one or more products or services of the multiple products or services;
activate the campaign;
detect second interactions of the user with first pages of the website, the second interactions including at least one of the user viewing one or more products or services of the multiple products or services, the user selecting one or more products or services of the multiple products or services for purchase, and the user purchasing one or more products or services of the multiple products or services;
update a profile of the user, the profile including the second interactions of the user with the first pages of the website;
evaluate the multiple offers for the one or more products or services of the multiple products or services and the profile of the user to identify one or more particular offers of the multiple offers to display to the user;
identify one or more particular offers of the multiple offers for the one or more products or services of the multiple products or services included in the campaign to display to the user;
receive a second theme, the second theme consistent with the first theme of the website;
generate, based on the second theme, a template and a stylesheet;
generate a visual indication of the one or more particular offers;
apply, using the template, the stylesheet to the visual indication of the one or more particular offers, such that the visual indication of the one or more particular offers has the second theme that is consistent with the first theme of the website;
display the visual indication of the one or more particular offers on second pages of the website, the visual indication having the second theme that is consistent with the first theme of the website, wherein to display the visual indication of the one or more particular offers on the second pages of the website includes to display the visual indication of the one or more particular offers as a persistent overlay on the second pages of the website;
receive a selection by the user of the visual indication;
generate the one or more particular offers;
apply, using the template, the stylesheet to the one or more particular offers, such that the one or more particular offers have the second theme that is consistent with the first theme of the website; and
display the one or more particular offers on the website, the one or more particular offers having the second theme that is consistent with the first theme of the website.
